(19) United States
(12) Patent Application Publication
(10) Pub. No.: US 2026/0158305 A1
(43) Pub. Date: Jun. 11, 2026

(54) FIRE EXTINGUISHING BLANKET WITH PROTECTIVE POCKETS

(71) Applicant: LUCH IP HOLDINGS LTD, NICOSIA (CY)

(72) Inventor: Andreas NORLIN, MARBELLA (ES)

(73) Assignee: LUCH IP HOLDINGS LTD, NICOSIA (CY)

(21) Appl. No.: 18/971,081

(22) Filed: Dec. 6, 2024

(51) Int. Cl. A62C 2/10

(52) U.S. Cl. CPC A62C 2/10

(57) ABSTRACT

A fire blanket has a first side and a second side. One of the sides has two pockets arranged such that a user, when the user inserts one hand into each pocket, may hold the fire blanket in such a way that his hands are protected from fire when the user uses the fire blanket to extinguish a fire.

### STATEMENT REGARDING PRIOR DISCLOSURES BY THE INVENTOR OR A JOINT INVENTOR

The following disclosure is submitted under 35 U.S.C. 102(b)(1) (A):
Disclosure: Published on the website http://usa.maussafety.com on Dec. 6, 2023.

### TECHNICAL FIELD

The present invention relates to a fire blanket and method for extinguishing a fire.

### BACKGROUND

Safety equipment for the home, working places or other location where potential dangers may arise is common precautions for preventing accidents. A simple but effective way of preventing a big fire or extinguishing a smaller fire is a fire blanket. A fire blanket is compact and easily foldable, allowing it to be stored conveniently in a variety of locations with minimal space requirements. When unfolded, it can be used to extinguish a fire by covering it, effectively cutting off the oxygen supply and suppressing the flames.

However, using a fire blanket to put out a fire involves certain risks of personal injury. As an example, hand injuries from using a fire blanket with bare hands are known.

### SUMMARY OF INVENTION

In a first aspect of the invention there is provided a fire blanket having a first side and a second side. One of the sides has two pockets arranged such that a user, when the user inserts one hand in each pocket, may hold the fire blanket in such a way that the hands are protected from fire when a user uses the fire blanket to extinguish a fire.

In some embodiments, the pockets have visual indications, instructing a user to place his hands into the pockets. This has the benefit of aiding the user for a safe and correct usage of the blanket, in particular in stressful situations.

In some embodiments, the material of the pockets comprises a fire-retardant material. This has the benefit of protecting the user's hands from getting too warm when using the fire blanket.

In some embodiments, the fire blanked is rectangular and the pockets are arranged at two corners of the rectangular fire blanket, said corners being connected by the same side of the rectangle. In this way, the user may spread out the full size of the entire blanket when using the pockets.

In some embodiments, the pockets are arranged with openings facing away from the edge of the fire blanket which is closest to the pocket. This has the benefit of protecting the user's hands from reaching outside the fire blanket edges.

In a second aspect of the invention there is provided a method for extinguishing a fire using a fire blanket as claimed, comprising:
a. a user inserting one hand into each of the two pockets, such that one side of the fire blanket faces away from the user, and
b. covering the fire by placing the side of the fire blanket that faces away from the user over the fire.

### BRIEF DESCRIPTION OF THE DRAWINGS

FIG. 1 shows an example of a fire blanket as with pockets arranged in two corners on the same side.

FIG. 2 shows an example of a fire blanket being used by a user.

FIG. 3 shows a block diagram of a method to use a fire blanket with two pockets.

### DETAILED DESCRIPTION

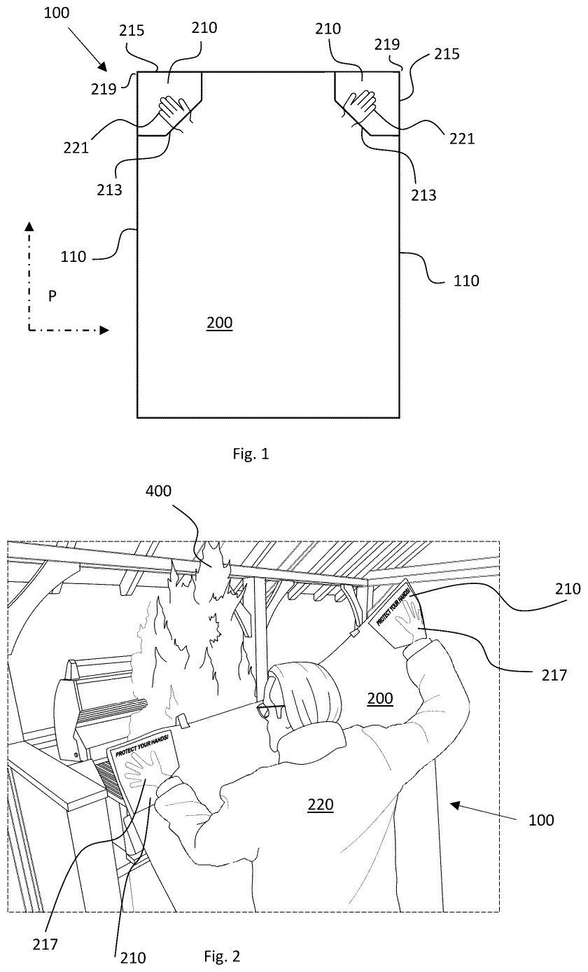

The various embodiments described herein suggest solutions to the above-mentioned problems. Fire blankets 100 as such are known. Fire blankets 100 are made of a fire-retardant material. FIGS. 1 and 2 show a fire blanket 100 according to one embodiment that has a first side 200 and a second side. A fire blanket 100 for personal use may have a size such that a user 220 can hold it and use it to extinguish a fire 400 by putting the fire blanket 100 over the fire 400 and thereby extinguishing the fire by depleting oxygen in the space below the fire blanket 100. The fire blanket 100 may have any suitable shape such as, for example, rectangular.

In the illustrated embodiment, the first side 200 has two pockets 210 arranged such that a user 220, when the user 220 inserts one hand 221 in each pocket opening 213, may hold the fire blanket 100 in such a way that his hands 221 are protected from a fire 400 when a user 220 uses the fire blanket 100 to extinguish the fire 400. The pockets 210 may be located at a distance from each other allowing a user 220 to spread out the fire blanket 100. A suitable distance may be for example from 100 cm to 200 cm. In various embodiments, in particular when the fire blanket 100 is rectangular, the pockets 210 are located at separate edges 110, of the first side 200 of the fire blanket 100 so that when the user 220 have inserted one hand in each pocket 210, the user 220 can spread out the fire blanket 100 to its maximum width in one direction of the fire blanket plane P. When the fire blanket 100 has the shape of a rectangle it may be useful for the pockets 210 to be located at the corners 219 of the rectangle.

In some embodiments, the extent of the fire 400 is smaller than the width of the fire blanket 100 in at least one direction of the plane P. The fire 400 may be extinguished by completely covering the fire 400 and thereby smother the fire 400 by cutting off the oxygen supply and suppressing the flames. In another embodiment, the fire 400 may be extinguished by covering the fire 400 completely in one direction, and only partly in another direction with the fire blanket 100. In that embodiment, the fire 400 is extinguished by covering one part at the time until the complete fire extent is smothered.

FIG. 1 shows an embodiment of how the pockets 210 may be arranged on the first side 200 of the fire blanket 100 at two adjacent corners 219 of a rectangular fire blanket 100. By inserting the user's hands 221 into each pocket 210, the user 220 may spread the fire blanket 100 to its maximum width. The pockets 210 may be arranged at other positions of the first side 200 than the corners 219 but be separated from each other in order to spread the fire blanket 100.

In some embodiments, the pockets openings 213 are arranged to face away from the closest edge 110 of the fire blanket. In some embodiments, the pocket openings 213 face away from the closest corner of the fire blanket 100. This has the advantage that the user's hands 221 do not reach outside the fire blanket's edges 110 and are therefore protected from the fire 400. Moreover, the fire blanket 100 will be suspended in front of the user 220 and it is therefore easier to cover the fire 400. FIGS. 1 and 2 show an example where the pocket openings 213 are located at the opposite sides of the fire blanket's corners 219. The pockets 210, apart from the pocket openings 213, are sealed, thereby protecting the hands 221 of the user 220 from reaching outside the edges 110 of the fire blanket 100.

FIG. 2 shows an embodiment where the pockets 210 have visual indications 217, instructing the user 220 to place his hands 221 into the pockets 210. In FIG. 2, the visual indication 217 is an image of a hand with a describing text. However, it should be noted that any visual indication 217 leading the user 220 to place his hands 221 into the pockets 210 could be used, such as an arrow, a color, a text, or the like.

The main part of the fire blanket 100 and the material forming the pockets 210 is preferably made of a fire-retardant material. The material may be pliable. The material may be a multilayer material. Useful materials include but are not limited to fiberglass, wool with fire retardant treatment, silicone coated fiberglass or carbon fiberglass. In some embodiments, the material comprises several layers, where the inside layer can have a heat insulating layer and the outermost layer can comprise a fire-retardant layer. The heat insulating layer may comprise, but is not limited to fiberglass, mineral wool, ceramic fibre, Kevlar, calcium silicate or the like.

The pockets 210 may be formed by attaching a layer of fire-retardant material to the piece of fire-retardant material which forms the main part of the fire blanket 100. For example, the layer may be attached along edges 110 by stitching or welding.

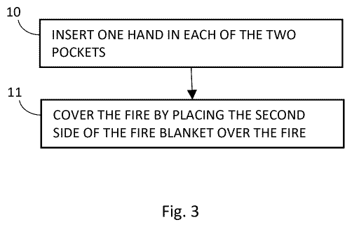

It is furthermore provided a method for using the fire blanket 100. The method is described in reference to FIG. 3. The method comprises using the fire blanket 100 with two pockets 210.

The method described in FIG. 3 starts with step 10, where the user 220 inserts one hand 221 into each of the at two pockets 210, such that the second side of the fire blanket faces away from the user 220.The visual indications 217 aids the user 220 to insert his hands 221 into the pockets 210. Once the user's hands 221 are inserted into the pockets 210, his hands 221 should not be able to reach outside the blanket edges 110 and are in that way protected from touching the fire 400.

Further, in step 11, the user 220 covers the fire 400 by placing the second side of the fire blanket 100 that faces away from the user 220 over the fire 400. In one embodiment, when the fire 400 is smaller than the area of the fire blanket 100, the user 220 may completely cover the fire thereby smothering the fire 400 by cutting off the oxygen supply and suppressing the flames.

In another embodiment, when the extent of the fire 400 is larger than the width of the fire blanket in one direction, the user may smother the fire 400 by covering the fire 400 completely in one direction, and only partly in another direction with the fire blanket 100. When the first partly covered section of the fire 400 is extinguished, the user 220 may continue to smother an adjacent part of the fire 400 and repeat this process until the whole fire 400 is completely smothered.

It should be noted that there are other approaches to extinguish a fire 400 with the fire blanket 100 and that the invention is not limited to the embodiments described above. For example, the user 220 may smother the fire 400 in any convenient way using the second side that faces away from the user towards the fire 400.

While the invention has been described with reference to specific exemplary embodiments, the description is in general only intended to illustrate the inventive concept and should not be taken as limiting the scope of the invention. The invention is generally defined by the claims.

1. A fire blanket having a first side and a second side wherein one of the sides has two pockets arranged such that a user, when the user inserts one hand in each pocket, may hold the fire blanket in such a way that the user's hands are protected from fire when a user uses the fire blanket to extinguish a fire.

2. The fire blanket of claim 1, wherein the pockets have visual indications, instructing a user to place the hands in the pockets.

3. The fire blanket of claim 1 wherein the material of the pockets comprises a fire-retardant material.

4. The fire blanket of claim 1, wherein the fire blanket is rectangular and the pockets are arranged at two corners of the rectangular fire blanket, said corners being connected by the same side of the rectangle.

5. The fire blanket of claim 4, wherein the pockets are arranged with openings facing away from the edge of the fire blanket which is closest to the pocket.

6. A method for extinguishing a fire using a fire blanket according to any one of claims 1 to 5, comprising:
a. a user inserting one hand into each of the two pockets, such that one side of the fire blanket faces away from the user, and
b. covering the fire by placing the side of the fire blanket that faces away from the user over the fire.
